(19) United States
(12) Patent Application Publication
(10) Pub. No.: US 2019/0169889 A1
(43) Pub. Date: Jun. 6, 2019

(54) DOOR HANDLE HAVING A MOVABLE EMERGENCY OPENING ELEMENT

(71) Applicant: HUF HÜLSBECK & FÜRST GMBH & CO. KG, Velbert (DE)

(72) Inventor: Andreas Beck, Bochum (DE)

(21) Appl. No.: 16/323,249

(22) PCT Filed: Jun. 23, 2017
(86) PCT No.: PCT/EP2017/065584

§ 371 Date: Feb. 4, 2019

(30) Foreign Application Priority Data
Aug. 4, 2016 (DE) 10 2016 114 494.0

(51) Int. Cl. E05B 81/90; E05B 79/20; E05B 85/10; E05B 77/02; E05B 81/76; E05B 81/86

(52) U.S. Cl. CPC E05B 81/90; E05B 79/20; E05B 81/86; E05B 77/02; E05B 81/76; E05B 85/10

(57) ABSTRACT

The invention relates to a door handle (10) for a vehicle door (100) of a motor vehicle, which door handle has a movable emergency opening element (11), which can be brought into a mechanical operative connection with a locking system (101) of the vehicle door (100), wherein the emergency opening element (11) has a traction means (12) for actuating the locking system (101), in particular for unlocking and/or for opening the vehicle door (100). The emergency opening element (11) is movable between at least two positions (I, II), namely a rest position (I), in which the emergency opening element (11) is fastened to the door handle (10), and an operating position (II), in which the emergency opening element (11) can be actuated by a user in order to actuate the locking system (101) by pulling on the traction means (12), and further comprising a triggering device (14) for the emergency opening element (11) in order to automatically transfer the emergency opening element (11) from the rest position (I) into the operating position (II), in particular in an emergency situation, wherein the emergency opening element (11) is arranged on an underside of the door handle (10).

The present invention relates to a door handle for a vehicle door or a vehicle hatch of a motor vehicle according to claim 1. In this case, the door handle is formed with a movable emergency opening element that can be brought into a mechanical operative connection with a closure system of the vehicle door, the emergency opening element comprising a traction means for actuating the closure system, in particular for unlocking and/or for opening the vehicle door, and the emergency opening element being movable between at least two positions, specifically a rest position in which the emergency opening element is fastened to the door handle apparatus, and an operating position in which the emergency opening element can be actuated by a user in order to actuate the closure system by pulling on the traction means, and a release apparatus for the emergency opening element, in order to transfer the emergency opening element automatically from the rest position into the operating position, in particular in an emergency situation. The invention furthermore relates to an emergency opening system for a vehicle door of a motor vehicle according to claim 25.

Movable door handles for motor vehicles are known that are movable between a closed position and an extended open position, in order to manually open a vehicle door. Furthermore, fixed door handles with sensors are known which are actuated without actively moving the door handle, for example by means of a hand grasping a door handle recess, in order to automatically open the vehicle door. In order to open the vehicle door, a closure system must first be actuated in order to unlock the vehicle door. In this case, mechanical closure systems are known which can be mechanically actuated by means of actuating a locking cylinder. Furthermore, automatic closure systems for vehicle doors are known which can be actuated without using a mechanical locking cylinder. Closure systems of this kind can be configured as active or passive keyless entry systems that allow for the vehicle door to be unlocked without active assistance of an authorized driver, and to be opened manually by pulling the door handle or automatically by actuating a sensor on the door handle. Closure systems of this kind can also be configured as keyless go systems that are fully automated and furthermore allow the motor vehicle to be started by simply actuating a start button. For this purpose, the driver must carry with him/her an electronic key in the form of an ID transponder in order to identify himself to a security system in the motor vehicle. Proximity sensors are mostly used in door handles of this kind, in order to first detect a presence of a user and then start an identification request in order to verify the authorization of the user. In this case, the security system can communicate with the ID transponder in order so to request an identification code. In the case of successful authentication of the authorized user, the closure system automatically unlocks the vehicle door and thus enables to open the vehicle door by pulling on a movable door handle or by activating a sensor on a fixed door handle.

In modern motor vehicles, an emergency opening system is generally provided for the vehicle door, in order that the closure system can still be actuated and the vehicle door opened in an emergency situation, for example in the event of an accident or the like, when the electronics and/or the energy supply for the closure system and/or for the sensors on the door handle fail. In order to optionally unlock the vehicle door beforehand and to finally open it, an emergency opening element may be provided on the door handle of the vehicle door, which element can be formed as to have a traction means. In this case, the traction means may be in a mechanical operative connection with the closure system in order to optionally first unlock and then open the vehicle door by pulling on the traction means. For this purpose, a slot may be provided on the door handle in order to raise the emergency opening element and release the traction means, by means of engaging in the slot using a tool, for example a screwdriver or an emergency key, such that it is possible to pull the traction means. In the case of the fixed door handles and/or automatic closure systems without a locking cylinder, it has been found in this case to be disadvantageous that, in the event of an accident, if the electronics fails and/or the energy supply is interrupted, the accident volunteers are impeded from opening the vehicle door in order to be able to administer first aid to the vehicle occupants. The situation may also arise in the case of movable door handles, however, that the door handle may jam and thus the vehicle door cannot be opened in an emergency situation, which is disadvantageous. Furthermore, the emergency opening elements, which are often painted in the car color, may not be easy to find. Moreover, it is disadvantageous for the emergency opening element to be damaged in the accident and to jam on the door handle with the result that it can no longer function correctly. In the worst case, first aid may then be administered too late.

The object of the present invention is therefore that of proposing a door handle for a vehicle door that overcomes at least one of the above-mentioned disadvantages at least in part. The object of the invention is in particular that of providing a door handle that ensures improved, in particular more reliable and simpler, actuation of the closure system and/or of the door handle of the vehicle door in an emergency situation.

In order to achieve this object, a door handle having the technical features of claim 1 and an emergency opening system according to claim 25 are proposed, having the following particular significance. Expedient embodiments of the invention are set out in the dependent claims. In this case, technical features that are disclosed in the context of the door handle according to the invention of course also apply in conjunction with the emergency opening system according to the invention and vice versa, and therefore reciprocal reference is or can be made in this respect.

In this case, the invention proposes a door handle for a vehicle door of a motor vehicle, said door handle being formed comprising a movable emergency opening element that can be brought into a mechanical operative connection with a closure system of the vehicle door, the emergency opening element comprising traction means for actuating the closure system, in particular for unlocking and/or for opening the vehicle door, and the emergency opening element being movable between at least two positions, specifically a rest position in which the emergency opening element is fastened to the door handle, and an operating position in which the emergency opening element can be actuated by a user in order to actuate the closure system by pulling on the traction means, and a release apparatus for the emergency opening element, in order to transfer the emergency opening element, in particular in an emergency situation, automatically from the rest position into the operating position, the emergency opening element being arranged on a lower side of the door handle.

In this case, the proposed door handle for motor vehicle doors can be used on the driver side and on the passenger side, as well as on the rear vehicle doors or on the trunk door or hatch. It is likewise possible to first release the traction means from the emergency opening element, for example by releasing a corresponding connection between the traction means and the emergency opening element, such as a form-fitting and/or force-fitting connection, a clip and/or clamped connection, a bayonet connection or the like, and subsequently initiating the opening process directly on the traction means. According to the invention a release apparatus for the emergency opening element is provided, in order to transfer the emergency opening element automatically into the operating position, in particular in an emergency situation. An emergency situation can be understood to be for example an accident, an electronics failure, a short-circuit, a dangerous lateral position, too high an acceleration, etc. In a situation of this kind, it may be important to first unlock the vehicle doors and to allow for simplified, quasi intuitive, actuation of the closure system.

According to the invention, in an emergency situation the emergency opening element is transferred automatically (i.e. autonomously, without action by a person) into the operating position, by means of a release apparatus that is provided especially. For this purpose, it is provided according to the invention, that the emergency opening element is arranged on a lower side of the door handle. In this case, the inventive concept is that in this position, the emergency opening element can be transferred most reliably into the operating position. In this position, the risk of the emergency opening element jamming on the door handle is minimized. In this case, it is advantageous for it to be possible to move the emergency opening element downwards towards the ground, out of the rest position and into the operating position. The emergency opening element according to the invention can thus be released from the door handle more easily than an emergency opening element on the upper face or on the front face of the door handle, since the emergency opening element can easily drop downwards and make use of its own gravitational force in the process. It is furthermore advantageous that it is thus easier for a accident volunteer to pull the emergency opening element and/or the traction means, in that the accident volunteer can more easily generate a tractive force towards the ground, using his own weight, than to the side, let alone upwards. Moreover, it is advantageous that less space is required around the vehicle in order to actuate the emergency opening element, because the emergency opening element can be actuated along the outer face of the vehicle door. In particular in the case of accidents in which the motor vehicle stops in a position having the vehicle door close to an obstacle, this may be a decisive advantage with regard to whether first aid can be administered at all. It is thus possible to ensure that access to the interior can be ensured despite all possible conceivable unfavorable conditions, in order to help the occupants as quickly as possible following the situation of an accident. As a result, it is possible not only for the emergency opening element to be found easily and handled simply, but also to be made easier for a helper to grasp in order to actuate the closure system by pulling on the emergency opening element. This results in the advantage that, if an emergency situation arises and normal operation of the door lock is not possible, it is not necessary to manually pull out the emergency opening element nor for the helper to search extensively as to how they can actuate the door lock, in order that the vehicle door can be opened easily if required. The release apparatus can preferably be arranged in the door handle at a protected position that is not directly visible, which can also take account of aesthetic considerations.

According to the invention, the closure system may be configured as a keyless go system. Alternatively, the closure system may be configured as a keyless entry system. According to both alternatives, corresponding sensors, for example contactless proximity sensors, such as capacitive sensors, can be integrated in the door handle. It is furthermore conceivable that a security system for the closure system comprising a corresponding transceiver unit for an identification request may be integrated in the door handle completely or in part. In this case, it is advantageous for said closure system to be able to lock and/or unlock the vehicle door without a mechanical locking cylinder when the authorization of the user has been verified. Subsequently, said closure system of this kind can automatically open and/or close the vehicle door when corresponding sensors in or on the door handle are actuated. A fully automatic closure system for the motor vehicle can thus be provided. With said closure systems, it is usually provided, that the closure system automatically unlocks all the vehicle doors in an emergency situation. However, if the electronics or the energy supply of a closure system of this kind fail, there is no mechanical locking cylinder available for emergency unlocking. The advantage is achieved, according to the invention, that, in spite of an accident or so an energy failure, a possibility is still provided for actuating the closure system in an alternative manner, in particular mechanically. For this purpose, the emergency opening element is automatically transferred or opened up into the operating position in an emergency situation in order to actuate the closure system using the traction means uncovered by the emergency opening element. The vehicle door can then optionally initially be unlocked, by pulling on the traction means. Subsequently, the vehicle door can be opened by further pulling on the traction means.

Furthermore, according to the invention the door handle may be formed as a fixed external door handle of a motor vehicle, and in particular one that is immovable relative to the door or hatch. In this case, the door handle can be fixedly mounted on the door or hatch. Said door handles can no longer be automatically opened in an emergency situation, if the electronics fails and/or simply in the case of a mere power failure or discharge of the battery. Even if the closure system is automatically unlocked (but not opened) following an emergency situation of this kind, pulling on a fixed door handle is pointless. In this case, the door lock continues to remain locked. The emergency opening element can subsequently be raised out only by expert intervention under or in the door handle, using a special tool, in order to open the door lock by pulling on the emergency opening element. However, if people are not familiar with the technology, there is a risk that it may not be possible to open the door in a stress situation. The invention overcomes this by proposing a special release apparatus for transferring the emergency opening element into the operating position in a fully automatic manner, without manual intervention. The remaining procedure can subsequently be carried out entirely intuitively. For this purpose, the auxiliary persons merely have to pull on the emergency opening element in order to purely mechanically actuate the door lock, and open the vehicle door, using the traction means attached to said emergency opening element.

It may furthermore be possible, within the context of the invention, that the emergency opening element may be loaded from the rest position into the operating position using an actuator, in particular a spring element. It is thus possible to achieve the advantage that the release apparatus can be additionally assisted by the actuator, in order to transfer the emergency opening element into the operating position in an emergency situation. As a result, sufficient release energy can always be provided for transferring the emergency opening element into the operating position, even in the case of an emergency opening element that is stuck or frozen in the rest position. Using a spring element enables to provide a simpler and more cost-effective actuator that can prestress the emergency opening element into the operating position. Alternatively, however, other embodiments of an actuator are conceivable which may assist the transfer of the emergency opening element out of the rest position into the operating position.

Furthermore, it may be provided according to the invention for the traction means to be designed for mechanically actuating the closure system. In addition, it may be possible according to the invention for the vehicle door to be locked by a central closure system of the motor vehicle. It is furthermore conceivable for the closure system to be configured mechanically and/or electrically actuatable. The traction means advantageously allows for mechanical actuation of the closure system if the electronics fails or if no energy is available for actuating the door lock in normal operation. In this case, the invention is equally applicable for purely mechanical or purely electrical closure systems and for combination closure systems. The use of a door handle according to the invention is also advantageous for other technologies, such as sensor-controlled, push button-controlled, or piezo element-controlled closure systems which require electrical actuation of the closure system in part. In this case, the traction means may be in operative connection with a sensor, a push button or a piezo element in order to enable an alternative, purely mechanical actuation of the respective element and/or the corresponding closure system in the operating position of the emergency opening element, by means of pulling on the traction means. It can thus still be possible, according to the invention, to open the vehicle door in an emergency. According to the invention, the door handle may form part of a security system of the motor vehicle which may be provided for the closure system of the vehicle door or of all doors, in order to ensure authorized and reliable actuation of the door lock.

Advantageously, the traction means may be configured flexibly, in the form of a so Bowden cable, a wire or plastics rope or a chain. It is furthermore conceivable that the traction means may be formed of a flexible, for example resilient, material. In this case, not only flexible metals, such as steel, are conceivable, but also plastics materials, such as fiber-reinforced plastics materials. This can achieve the advantage that, when the emergency opening element is raised by the traction means, easy access to an emergency actuator of the closure system arranged in the external door handle, and thus an opening mechanism or a door lock of the vehicle door, can be provided.

According to the invention, the emergency opening element may comprise a for example form- and/or force-locking loss-prevention means, in particular in the form of a latching, clip and/or clamping element, a bayonet connection, a joint or a hinge, for holding the emergency opening element loss resistant on the door handle in the operating position. This results in the advantage that the emergency opening element can be secured in the operating position in a form- and/or force-locking manner, such that the emergency opening element cannot accidentally fall out or be lost in the event of detachment or removal. In the operating position, the emergency opening element can thus initially be held loosely on the door handle and be ready for actuation. It is furthermore conceivable that in particular the loss-prevention means may be an extension of the traction means. This way, a simplified connection between the emergency opening element and the traction means can be created, which connection can simultaneously function as a loss-prevention and/or installation aid for the emergency opening element.

Advantageously, according to the invention, the release apparatus may comprise an arresting element for the emergency opening element, in particular in the form of at least one clamping, latching or clip element, which may be movable between at least two positions, specifically an arrested position in which the arresting element can secure the emergency opening element in the rest position, in particular in a force- and/or form-fitting manner, and a release position in which the emergency opening element can be released in the emergency opening element for transfer into the operating position by means of the arresting element. On the one hand, this results in the advantage that the emergency opening element always remains rigidly and securely fixed at one position on the door handle, specifically the rest position, even when the motor vehicle is in driving mode, despite the influence of vibrations inside the door handle. On the other hand, this results in a reduction in noises that may result inside the door handle owing to movement of a detached emergency opening element.

It may furthermore be possible, according to the invention, that the arresting element may be loaded from the release position into the arrested position using an actuator, in particular a spring element. This can achieve the advantage that, in normal operation of the motor vehicle, the arresting element can be reliably retained in the arrested position in order to prevent rattling and detachment of the arresting element inside the door handle. Using a spring element enables to provide a simpler and more cost-effective actuator that can preload the arresting element into the arrested position.

It is furthermore conceivable, within the context of the invention, that the arresting element may be retained on the emergency opening element using an actuator, in particular a spring element, it being possible for the actuator to generate a release force on the emergency opening element when the arresting element is transferred from the arrested position into the release position, which force can move the emergency opening element from the rest position into the operating position. In this case, the actuator advantageously releases an additional release force which can be acquired by the actuator from the movement of the arresting element, in order to increase the preload on the emergency opening element and to allow for sudden transfer of the emergency opening element into the operating position. It is thus possible to achieve the advantage that the emergency opening element can spring out, in the operating position, in order to be easily visible and simple to grasp for the first responders.

It may be possible, according to the invention, for the emergency opening element to comprise a slot in order for it to be possible to act mechanically on the emergency opening element, in particular on the arresting element, and to transfer the emergency opening element into the operating position, and in particular to transfer the arresting element into the release position, by means of inserting an opening means, for example a key bit of an emergency key, into the slot. This results in the advantage that the emergency opening element can be actuated purely manually in the case of a simple power failure. In this case, the emergency opening element can be “tilted off” or “jemmied off” the external door handle by means of inserting a suitable object into the slot. At the same time, it is conceivable that the arresting element may be actuated by inserting a suitable object into the slot, in order to transfer the arresting element out of the arrested position and into the release position. The emergency opening element can then automatically spring into the operating position, for example by means of the action of a relief pressure of an actuator, for example in the form of a spring element, which can preload the operating position into the operating position thereof.

According to the invention, the release apparatus may comprise a release means in order for it to be possible, in the event of an accident or an emergency situation, to directly or indirectly act on the emergency opening element, in particular on the arresting element, automatically, in particular mechanically, electrically, electromagnetically, electromechanically or pyrotechnically, and to transfer the emergency opening element into the operating position, in particular to transfer the arresting element into the release position. In this case, the invention proceeds from the concept that a further emergency operating mode may be provided, in addition to a normal operating mode of the closure system when all the systems operate as intended and sufficient energy is available for automatic actuation of the closure system, and in addition to the operating mode when the energy is not available, in particular when the car battery is drained, and only manual actuation of the emergency opening element is possible. Said emergency operating mode is provided for the cases where an emergency situation arises, but also for the cases where the energy is simply used up. According to the invention, in this case the release apparatus, in particular release means, causes the emergency opening element or the arresting element to be actuated directly or indirectly, in order to transfer the emergency opening element into the operating position or to transfer the arresting element into the release position. In this case, it is conceivable that the release means may be activated when all further systems have failed or are temporarily not operational. The release means may make use of various technologies in order to trigger in an emergency situation. In this case, mechanical functioning of the release means is conceivable, for example if, in the case of an accident, the deformation energy of the vehicle outer skin or the movement of a crash lever is used to actuate the release means. Electrical functioning of the release means is conceivable for example if the emergency situation serves to activate an emergency energy store in order to activate the release means. Combined electromagnetic or electromechanical functioning of the release means is likewise conceivable in this case, if the mechanical deformation can bring about electrical or magnetic activation of the release element. Firstly, but not lastly, pyrotechnical functioning of the release means is possible if a deliberate, minimal explosion, caused by the emergency situation, can result in activation of the release element. A crash sensor, an acceleration sensor, a tilt sensor or the like may be used as a release sensor (also referred to as an emergency situation sensor or crash sensor) for the electrical functioning of the release means.

According to the invention, it may furthermore be provided for the release means to be configured in the form of a shape memory alloy element (SMA element), a permanent or electric magnet, e.g. a coil, a piezo element or a pyrotechnic element. Advantageously, the shape memory alloy element can be energized after an emergency situation is identified, as a result of which said element can heat up and thus mechanically contract. The mechanical deformation of the shape memory alloy element can then be used, according to the invention, to activate the release apparatus in order to transfer the arresting element into the release position and/or to transfer the emergency opening element into the operating position. In this case, the release means may advantageously be produced from a shape memory alloy, in the form of a wire that may have a diameter of between 0.1 mm and 1 mm, in particular between 0.2 mm and 0.8 mm, in particular 0.4 mm. In this case, the shape memory alloy element can generate a tensile force of at least 20 to 80 N, in particular 25 N, in all temperature ranges, from −40 to +85° C., in order to actuate the emergency opening element or the arresting element. Said tensile force can be generated after a brief current application of from 0.1 to 2 s, in particular 0.5 s. In this case, the current need not be applied above 3.5 A in the case of a preferred voltage in the motor vehicle of preferably 12 V. A release means in the form of a permanent magnet may displace the permanent magnet, for example owing to the deformation of the door panel, in such a way as to attract or repel the arresting element and/or the emergency opening element and/or a pressure means or a retaining means for the arresting element or for the emergency opening element, in order to accordingly actuate the arresting element and/or the emergency opening element. Instead of the permanent magnet, a coil may also be used for the necessary magnetic force, which coil can likewise be energized. A piezo element can optionally convert the mechanical deformation energy of the door panel into electrical energy in order to actuate the arresting element and/or the emergency opening element. The piezo element can also be energized by the release sensor. Finally, it is conceivable that it may be possible for a pyrotechnic element to be activated by mechanical deformation energy of the door panel, as a result of which a deliberate, controlled explosion can be initiated in order to actuate the arresting element and/or the emergency opening element. In this case, it is likewise conceivable for the release sensor to be able to activate the pyrotechnic element.

For this purpose, it may be provided, according to the invention, for the release apparatus to be able to be connected to at least one emergency situation sensor or crash sensor, it being possible for the release apparatus to be activated, in particular when an emergency situation is detected by the at least one emergency situation sensor, in order to transfer the emergency opening element into the operating position, in particular to transfer the arresting element into the release position. Different emergency sensors are conceivable in this case, which sensors can detect the values that stand out owing to an accident, such as too large an angle of inclination, too high a speed or acceleration, or too great a mechanical deformation of the motor vehicle, or the like.

According to the invention, the emergency opening element and the traction means may be interconnected directly or via a connection means. In this case, the connection means may be formed in the manner of a receptacle, a hook, an eyelet, a clamp or a clip, in particular on the emergency opening element, in order to engage on the traction means. This results for example in the advantage that the traction means can be connected to the emergency opening element in a simple manner. In particular, within the context of installation, an end of the traction means can be quickly and easily connected to the connection element. As a result, this simplifies both the purely mechanical actuation of the traction means and the emergency activation of the traction means via the emergency opening element by the release apparatus.

It may furthermore be advantageous for the emergency opening element and the connection element to be integral, in particular to be formed as a monolithic component. In other words, the emergency opening element and the connection element may be manufactured as an integral component, for example an injection-molded part. This results in the advantage that the complexity can be reduced by producing the two elements as just one component, because at least one process step of joining the connection element and the emergency opening element is saved. Furthermore, this results in the advantage that improved tensile force can be transmitted from the emergency opening element to the traction means in the event of it being necessary to actuate the traction means. Consequently, when operating or actuating the traction means, a user does not need to first actuate the emergency opening element and then find the end of the traction means in order to be able to actuate the door lock, but can instead pull out the traction means and effect emergency opening of the vehicle door simply by grasping and pulling the emergency opening element.

Advantageously, the door handle and/or the emergency opening element can be formed of a plastics material, in particular in the form of a plastics injection-molded part. This allows for cost-effective and simple production as well as a reduction in the weight of said elements.

According to the invention, the emergency opening element may be arranged in an opening of the door handle, it being possible for a sealing element to be provided on the emergency opening element and/or on the door handle, in particular surrounding the opening. The sealing element enables to achieve the advantage that no external moisture or dirt can reach the inside of the door handle. An opening in the door handle allows access to the traction means, which is hidden inside the door handle during normal operation of the motor vehicle.

According to the invention, it may be advantageous for the emergency opening element to comprise a cover element for covering an opening of the door handle in which the emergency opening element is arranged. In this case, the shape of the cover element can advantageously be adapted to the outer face of the handle in order to allow for a smooth and flush transition between the cover element and the outer surface of the door handle. In this case it is conceivable that the cover element may be formed in the shape of a straight or slightly concave plate or a plateau. The emergency opening element can thus be optically matched to the shape of the handle, in order not to impair the external appearance of the door handle in normal operation of the motor vehicle. Furthermore, the emergency opening element may comprise a fastening element, for example in the form of a projection-like pin, which can be brought in mechanical connection with the release apparatus and the traction means. In this case, the fastening element may advantageously be arranged completely inside the door handle and comprise corresponding means for being functionally connected to the traction means, to the release apparatus and optionally to an actuator, as well as to a loss-prevention means. All the essential functional connections can thus be established in a manner protected in the door handle. In this case it is furthermore advantageous that only the cover element needs to be matched to the look and the shape of the door handle. As a result, the costs for producing the emergency opening element can be reduced and the production itself can be simplified. In this case, it is conceivable that the cover element and the fastening element may be formed monolithically and/or from one material, as an integral injection-molded component.

It is furthermore possible, within the context of the invention, that the door handle and/or the emergency opening element, and in particular the cover element, may comprise an in particular metal coating. In this case, it is conceivable that the door handle and/or the emergency opening element may be chrome-plated and/or painted on the outside, in order to ensure that the vehicle door has an even, high-quality appearance. It is furthermore conceivable that by the coating, a sealing of the interior of the door handle can be achieved.

In this case, it may be advantageous if at least one proximity sensor, in particular in the form of a capacitive, optical or acoustic sensor or a pressure sensor, can be integrated in or on the door handle, in particular below the emergency opening element, in order to detect a user approaching the motor vehicle. After such an approach has been identified, the security system in the motor vehicle can be activated in order to carry out an authorization request using an ID transponder. Subsequently, in the case of positive authentication, by means of a further sensor in the door handle, can be detected the authorized user's intention of opening the vehicle door, for example when a hand of the user is sensed entering the handle cup of the door handle. In this case, two proximity sensors, in particular two capacitive sensors, can advantageously be integrated in the door handle, in particular below the emergency opening element, in order to be able to monitor a region facing outwards from the door handle so as to detect a user approaching, and in order to be able to monitor a region in the handle cup facing inwards from the door handle so as to detect an intention of opening.

Within the context of the invention, it is furthermore conceivable that a control unit may be provided for the release apparatus, in order to actuate the release apparatus. In this case, the control unit may be formed as a separate control unit and integrated in the door handle. The advantage in this case is that an autonomous unit for emergency actuation of the closure system can thus be created. For this purpose, now only the traction means needs to be guided towards the closure system.

It may be provided, according to the invention, that an emergency power supply may be provided for the release apparatus, and in particular for the control unit. In this case it is conceivable that the emergency power supply may comprise at least one capacitor, a Goldcap capacitor, an accumulator or a foil accumulator in order to supply the release apparatus, and in particular the control unit, with energy. The advantage in this case is that the release apparatus and in particular the control unit can thus be designed having a separate emergency energy source. In this case, the emergency power supply may comprise a mechanism that makes use of the emergency situation in order to provide energy, for example by making use of acceleration, braking and/or deformation energy. In this case it is advantageous that the control unit and the release apparatus thus act in a manner independent of all other vehicle systems and can function without interference, even in an emergency. In this case, the corresponding electronics and the associated emergency situation sensors may be integrated in the door handle, together with the control unit.

The object according to the invention is furthermore achieved by an emergency opening system for a vehicle door of a motor vehicle according to claim 25, comprising a door handle described above and a closure system for locking and/or unlocking and/or for opening and/or closing the vehicle door. In this case, different technologies can be used for the closure system for locking and unlocking the vehicle door, for example automatically, following an authorization request, using a central locking system, or manually using a locking cylinder. Various technologies can also be provided for opening and closing the vehicle door, for example automatically by actuating a sensor on the door handle or manually by pulling on the door handle. In this case, the door handle according to the invention is compatible with various technologies. According to the invention, the closure system can be actuated by pulling on the traction means, it being possible for the vehicle door to optionally be unlocked first and for the vehicle door to subsequently be opened, for example by further pulling on the traction means. If the vehicle comprises an automatic emergency release mechanism for the vehicle doors, for example if an ignition key is pulled out of an ignition, when one of the doors is opened from the inside, or in the event of an accident registered by the emergency situation sensor, it is then possible to use the traction means only for opening the vehicle door. However, in vehicles of this kind the automatic emergency unlocking mechanism may also fail following an accident, and it is therefore advantageous to create a possibility for first unlocking the vehicle door using the emergency opening element. When the vehicle door is then unlocked, the vehicle door can be opened by further pulling on the traction means. In this case, it is advantageous in particular that the emergency opening system according to the invention can be used for a closure system without a locking cylinder, because a closure system of this kind is created the possibility of unlocking the closure system mechanically, even without the locking cylinder. Closure systems of this kind without a locking cylinder can comprise only one door lock on the driver's door, which lock may be located remote from the door handle on the driver's door, and remote from the door handles on other vehicle doors or hatches. In this case, the emergency opening system according to the invention advantageously allows for a remote mechanical connection between the door lock and the relevant door handle or the relevant emergency opening element, such that each vehicle door can be optionally unlocked and opened in an emergency situation by means of mechanically actuating the emergency opening element on each door handle. In this case, the closure system or the door lock can be actuated electrically, by means of a switch, in normal operation, or mechanically, by pulling on the traction means, in an emergency situation. The emergency opening system according to the invention also achieves the same advantages as described above in conjunction with the door handle according to the invention. In order to avoid repetition, reference is made here to the advantages of the door handle according to the invention, in their entirety.

It is furthermore conceivable, according to the invention, that a security system may be provided for the closure system in order to request authorization of a user. In this case it is conceivable that a corresponding transceiver unit of the security system may already be implemented in the door handle. A control unit for the security system may also be implemented in the door handle. However, it is alternatively possible, within the meaning of the invention, that the security system and/or the control unit may be moved to a central location in the motor vehicle and may form part of the emergency opening system according to the invention.

It is moreover conceivable that a control unit may be provided for the closure system, in particular for the release apparatus, which unit may be integrated in a central control unit of the motor vehicle. It is thus possible to achieve the advantage so that the emergency opening system according to the invention can be compatible with a central and/or automatic closure system of the vehicle door. The structure of the door handle can be simplified thereby.

Further measures and advantages, as well as technical features, of the invention can be found in the claims, the following description and the drawings. In this case, different features may be advantageous alone and in any desired combination, without departing from the scope of the invention. The following figures are detailed depictions of multiple exemplary embodiments of the door handle according to the invention. In the figures:

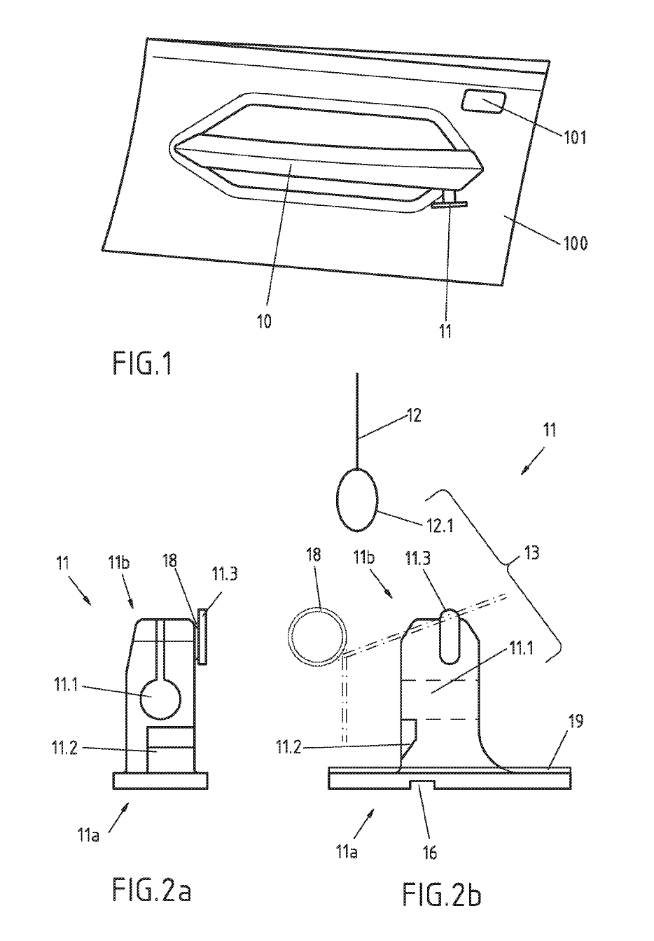

FIG. 1 is a schematic illustration of a door handle according to the invention on a vehicle door,

FIG. 2a is a schematic illustration of an emergency opening element according to the invention in a side view,

FIG. 2b is a schematic illustration of the emergency opening element according to the invention in a front view,

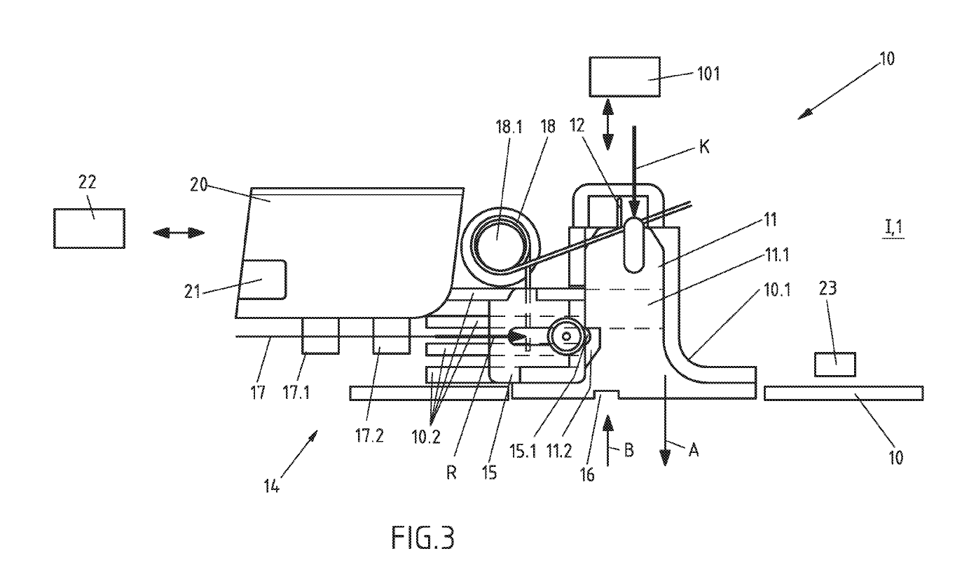

FIG. 3 is a schematic illustration of the emergency opening element according to the invention in a rest position on the door handle, and

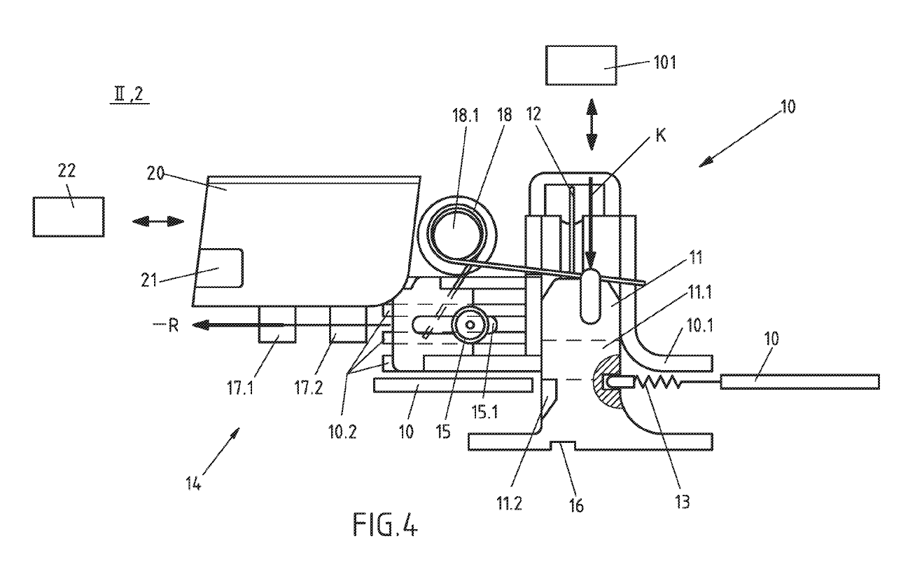

FIG. 4 is a schematic illustration of the emergency opening element according to the invention in an operating position, released from the door handle.

In the following figures, identical reference characters are used for the same technical features, even in different exemplary embodiments.

FIG. 1 shows a door handle 10 according to the invention, on a vehicle door 100, said handle being designed having a movable emergency opening element 11. A closure system 101 is furthermore indicated schematically on the vehicle door 100. In this case, the closure system 101 may be designed for unlocking and locking a door lock (not shown) and/or for opening and closing the vehicle door 100. In this case, the door handle 10 may be part of a security system in the motor vehicle.

It is essential, according to the invention, for the emergency opening element 11 to be arranged on a lower side of the door handle 10. The emergency opening element 11 can be transferred into an operating position II most reliably from this position under the door handle 10, as shown in FIG. 1. In this case, the emergency opening element 11 can be moved downwards into the operating position II, such that the emergency opening element 11 cannot jam and can be more easily released from the door handle 10. It is thus also easier for an accident volunteer to pull the emergency opening element 11.

In this case, the accident volunteer can easily and comfortably built-up traction downwards using his own weight. Furthermore, it is thus possible to take account of the fact that the emergency opening element 11 can be actuated in a space-saving manner along the outer face of the vehicle door 100 in the case of there being limited space around the vehicle. In particular in the case of accidents in which the motor vehicle stops in a position having the vehicle door 100 close to an obstacle, this may be important in order for it to be possible to open the vehicle door 100 mechanically using the emergency opening element 11. The emergency opening element 11 can also be found more easily owing to the arrangement thereof under the door handle 10. This results because a downwardly extending emergency opening element 11 can be optically more prominent on the door handle 10 than an emergency opening element 11 on the front or above the door handle 10, when the door handle 10 is viewed from above.

According to the invention, the emergency opening element 11 is mounted so as to be movable between at least two positions: a rest position I in which the emergency opening element is fastened to the door handle 10 and which is shown in FIG. 3, and an operating position II in which the emergency opening element 11 is freely accessible from the outside, as shown in FIG. 1 and subsequently in FIG. 4. In the operating position II, the emergency opening element 11 can be actuated by a user in order to actuate the closure system 101 by pulling on the emergency opening element 11 and/or a traction means 12 fastened thereto, which is shown in FIGS. 2 to 4.

The door handle 10 shown may be a fixed door handle 10 which can be actuated using sensors, for example in a contactless manner, in order to open the vehicle door 100. According to the invention, the closure system 101 may be formed on the vehicle door 100 in the manner of a keyless entry system or a keyless go system without a locking cylinder, and may be connected to a security system for an authorization request. In normal operation, the closure system 101 serves for automatically unlocking the vehicle door 100 without active intervention by an authorized user and for automatically opening the vehicle door 100. If the electronics 20 in the motor vehicle is no longer functioning owing to an accident, and/or if the vehicle battery is drained, the automatic actuation of the closure system 101 cannot be achieved, because the energy for operating the proximity sensors 23 or for the security request is not available. In this case, the invention provides a reliable option for actuating the closure system 101 even without a locking cylinder, as is explained in detail in the following, with reference to FIGS. 3 and 4.

FIGS. 2a and 2b show the emergency opening element 11 according to the invention, which can be brought into a mechanical operative connection with a closure system 101 of the vehicle door 100. In this case, the emergency opening element 11 comprises a cover element 11a for areally covering an opening in the door handle 10 in which a fastening element 11b of the emergency opening element 11 is arranged. In this case, the cover element 11a is matched to the shape of the door handle 10 in order to form a smooth, flush surface of the door handle 11. In this case, the cover element 11a is designed in the form of a flat or slightly curved plateau to which a fastening element 11b is molded in the manner of a projection, which element can be inserted, as a pin, into the corresponding opening on an installation element 10.1 of the door handle 10. Installation of the emergency opening element 11 on the door handle 10 can be significantly simplified thereby. Various mechanical means 11.1, 11.2, 11.3 are formed on the fastening element 11b, which means can interact with a release apparatus 14, a traction means 12 and a spring element 18. In this case, the cover element 11a and the fastening element 11b form each a monolithic and integral component which may be formed from a plastics material by means of an injection-molding process for example. In this case, the door handle 10 and the cover element 11a may comprise a chromium or paint coating which can optionally be used for sealing the interior of the door handle 10. It is furthermore conceivable that a seal 19 may additionally be provided on the inside of the cover element 11a or on a complementary surface on the installation element 10.1.

A slot 16 may be provided on the cover element 15 in order to raise the emergency opening element 11, and then be able to pull said element more comfortably, by means of engaging for example an edge of an emergency key or another suitable tool in the slot 16. A connection means 11.1 for connecting to the traction means 12, for example in the form of a through-opening 11.1, may be provided on the fastening element 11b, through which opening the traction means 12, for example in the form of a Bowden cable 12, is guided, and is fastened using a complementary connection means 12.1, for example in the form of a loop 12.1. The connection means 11.1 on the emergency opening element 11 and the complementary connection means 12.1 on the traction means 12 together form a loss-prevention means 13 for the emergency opening element 11, which loss-prevention means ensures that the emergency opening element 11 is held in the operating position II on the door handle 10 and is not lost, even if the emergency opening element 11 is pulled out. As an alternative to FIGS. 2a and 2b, the connection means 11.1 can be configured in the form of a hook on which the loop 12.1 can be fastened. In addition, a plurality of further embodiments for the connection means 11.1 and the complementary connection means 12.1 are conceivable, which can create a loss-prevention means 13 and which can ensure a for example form- and/or force-locking, preferably releasable, connection between the emergency opening element 11 and the traction means 12. It is alternatively also conceivable, however, that the emergency opening element 11 and the traction means 12 may be integrally interconnected, for example by means of an adhesive, or may even be formed as a single integral component from one material or from one composite material. It is furthermore conceivable that the traction means 12 may be formed of a resilient material which can transmit a tensile force over a non-straight path. A latching element 13 can furthermore be used as an additional loss-prevention means 13, which latching element is indicated by way of example in FIG. 4, between the installation element 10.1 and the cover element 11a. According to the invention, the traction means 12 leads out of the door handle 10 and to the closure system 101, in order to mechanically actuate the closure system 101 by pulling on the traction means 12. The operational functioning of the closure system 101 can per se equally be mechanical, electrical or electromechanical.

Furthermore, a mating latching means 11.2, for example in the form of a notch 11.2, may be provided on the fastening element 11b in order to interact in a form- and/or force-locking manner with an arresting element 15 in the rest position I of the emergency opening element 11. As an alternative to a notch 11.2, any desired form- and/or force-locking means is conceivable, which can interact with the arresting element 15. Furthermore, the fastening element 11b may be designed having a spring holding means 11.3 for holding a spring element 18 thereon. In this case, the spring holding means 11.3 is formed in the manner of a projection 11.3, on which the spring element 18 can be supported. Alternatively, the spring holding means 11.3 may be formed in the manner of a hook, in which the spring element 18 can rest. The functioning of the arresting element 15 and of the spring element 18 will be explained in the following with reference to FIGS. 3 and 4.

In this case, FIG. 3 shows the emergency opening element 11 according to the invention in the rest position I, and FIG. 4 shows said element in the operating position II. FIG. 3 furthermore shows a release apparatus 14 comprising an arresting element 15, by means of which the emergency opening element 11 is secured in that a latching means 15.1, for example in the form of a latching means 15.1, in which the notch 11.2 on the emergency opening element 11 engages as a mating latching means 11.2. The arresting element 15 can be raised out of the notch 11.2, in order to release the emergency opening element 11. According to the invention, the arresting element 15 has two positions: an arrested position 1, in which the arresting element 15 holds the emergency opening element 11 in the rest position I in a form- and/or force-locking manner (see FIG. 3), and a release position 2, in which the arresting element 15 releases the emergency opening element 11 in order to be transferred into the operating position I (see FIG. 4). In this case, it is advantageous that the emergency opening element 11 remains securely fixed in the rest position II and no rattling sounds arise, even in travel mode of the motor vehicle. If the arresting element 15 is pulled in the direction -R, as shown in FIG. 4, the arresting element 15 is thus transferred from the arrested position 1 into the release position 2. In this case, the arresting element 15 is guided so as to be linearly movable, on special rails 10.2 on the installation element 10.1 or on the door handle 10, in order to allow for stable transfer of the arresting element 15 from the arrested position 1 into the release position 2, and thus to perform a reliably transfer of the emergency opening element 11 out of the rest position I and into the operating position II. The emergency opening element 11 is thus freed and conveyed into the operating position II by spring element 18, by means of the action of a release force K, with the result that the emergency opening element 11 is released suddenly from the door handle 10. Alternatively it is nonetheless conceivable, however, that it may be possible to raise the emergency opening element 11 using the suitable tool that can engage in the slot 16 in the direction B.

The emergency opening element 11 is loaded, by means of the spring element 18, out of the rest position I and into the operating position II, in the direction A. In this case, the spring element 18 is formed in the manner of a torsion spring, one leg of the spring element 18 being supported on the spring holding means 11.3 of the emergency opening element 11 and another leg of the spring element 18 being supported on the arresting element 15. The spring element 18 thus loads the arresting element 15 out of the release position 2 and into the arrested position 1, in the direction R. A preload force is generated between the two legs, which force ensures that a release force K acts on the emergency opening element 11 when the latching means 15.1 on the arresting element 15 is released from the mating latching means 11.2 on the emergency opening element 11, which force allows the emergency opening element 11 to suddenly come off the door handle 10. In this case, the spring element 18 is arranged on a cam 18.1 on the installation element 10.1.

A specially designed release means 17, for example in the form of a shape memory alloy element, can allow for the arresting element 15 to be able to be moved into the release position 2, i.e. in the direction -R counter to the tensioning force R of the spring element 18, in order to release the emergency opening element 11. In this case, the release means 17 is formed in the manner of a wire, from a shape memory alloy, which wire is guided in the interior of the door handle 10 on corresponding guide means 17.1, 17.2 in the form of hooks. After an emergency situation is identified by an emergency situation sensor 22 (shown schematically), the release means 17 can be energized by a control unit 20, as a result of which said element can heat up and thus mechanically deform, in particular contract. The mechanical deformation of the shape memory alloy element 17 is used, according to the invention, to transfer the arresting element 15 into the release position 2. In order to obtain the necessary energy, an emergency power supply 21, for example in the form of a battery, may be provided in the door handle 10. Alternatively, it is likewise conceivable that the emergency situation may be able to be used for the emergency power supply 21, for example the deformation energy of the door panel may be converted into electrical energy, or the like. The mating latching means 15.1 is released from the latching means 11.1 in the direction -R and thus releases the emergency opening element 11. In addition it may be possible, according to the invention, for the release means 17 to be able to make use of various technologies in order to be actuated in an emergency situation. In this case, mechanical, electrical, combined electromagnetic or electromechanical, and pyrotechnical actuation of the release means 17 is conceivable.

In this case, the control unit 20 shown in the door handle 10 may function as a special control unit 20 for the release apparatus 14. Alternatively it is also conceivable, however, that the control unit 20 may be arranged in a central control unit 20 of the motor vehicle. In this case, the control unit 20 may also be designed for actuating the emergency situation 22 and the proximity sensor 23. In this case, the proximity sensor 23 may form part of a security system in the motor vehicle, for executing an authorization request.

Finally, it should also be noted that the embodiments and variants of the door handle 10 according to the invention shown here can be combined with one another as desired, provided said combinations do not explicitly mutually exclude themselves.

### LIST OF REFERENCE CHARACTERS

10 door handle
10.1 installation element
10.2 rails on the installation element for an arresting element
11 emergency opening element
11.1 connection means
11.2 mating latching means/notch
11.3 spring holding means
11a cover element
11b fastening element
12 traction means
12.1 complementary connection means/loop
13 loss-prevention means
14 release apparatus
15 arresting element
15.1 latching means/lug
16 slot
17 release means/shape memory alloy element
17.1 guide means
17.2 guide means
18 spring element
19 sealing element
20 control unit/electronics
21 emergency power supply
22 emergency situation sensor
23 proximity sensor
100 vehicle door, vehicle hatch, body
101 closure system
I rest position of the emergency opening element
II operating position of the emergency opening element
1 arrested position of the arresting element
2 release position of the arresting element
A direction for automatically transferring the emergency opening element into the operating position
B direction for engaging in the slot
K release force
R tensioning force

1. A door handle for a vehicle door of a motor vehicle, comprising:
a movable emergency opening element which can be brought into a mechanical operative connection with a closure system of the vehicle door,
wherein the emergency opening element comprises a traction means for actuating the closure system,
and wherein the emergency opening element is movable between at least two positions, specifically
a rest position, in which the emergency opening element is fastened
to the door handle,
and an operating position, in which the emergency opening element can be actuated by a user, in order to actuate the closure system by pulling on the traction means,
and a release apparatus for the emergency opening element, in order to transfer the emergency opening element automatically out of the rest position and into the operating position,
wherein the emergency opening element is arranged on a lower side of the door handle.

2. The door handle according to claim 1, wherein the closure system is designed as a keyless go system or as a keyless entry system.

3. The door handle according to either claim 1, wherein
the door handle is configured as a fixed external door handle of a motor vehicle.

4. The door handle according to claim 1, wherein
the emergency opening element is loaded, by means of an actuator, out of the rest position and into the operating position.

5. The door handle according to claim 1, wherein
the traction means is configured for mechanically actuating the closure system.

6. The door handle according to claim 1, wherein
the traction means is configured in the type of a Bowden cable or a chain.

7. The door handle according to claim 1, wherein
the emergency opening element comprises at least an loss-prevention means, clip and/or clamping element, a bayonet connection, a joint or a hinge, for holding the emergency opening element loss resistent in the operating position.

8. The door handle according to claim 1, wherein
the release apparatus comprises an arresting element for the emergency opening element, which is movable between at least two positions, specifically an arrested position in which the arresting element secures the emergency opening element in the rest position
and a release position, in which the arresting element releases the emergency opening element in order to be transferred into the operating position.

9. The door handle according to claim 1, wherein
the arresting element is loaded, by means of an actuator, out of the release position and into the arrested position.

10. The door handle according to claims 1, wherein
the arresting element is held on the emergency opening element by means of an actuator, wherein the actuator generates a release force on the emergency opening element when the arresting element is transferred out of the arrested position and into the release position, which force carries the emergency opening element out of the rest position and into the operating position.

11. The door handle according to claim 1, wherein
the emergency opening element comprises a slot for acting mechanically on the emergency opening element, and to transfer the emergency opening element into the operating position, by means of inserting an opening means into the slot.

12. The door handle according to claim 1, wherein
the release apparatus comprises a release means in order, in the event of an accident, to act on the emergency opening element, and to transfer the emergency opening element into the operating position.

13. The door handle according to claim 12, wherein
the release means is configured in the form of a shape memory alloy element, a permanent or electric magnet, or a piezo element.

14. The door handle according to claim 1, wherein
the release apparatus can be connected to at least one emergency situation sensor or crash sensor, wherein it is possible for the release apparatus to be activated in order to transfer the emergency opening element into the operating position.

15. The door handle according to claim 1, wherein
the emergency opening element and the traction means are interconnected directly or via a connection means.

16. The door handle according to claim 1, wherein
the connection means is formed in the manner of a receptacle, a hook, an eyelet, a clamp or a clip, in order to engage on the traction means.

17. The door handle according to claim 1, wherein
the emergency opening element and the traction means are configured integral.

18. The door handle according to claim 1, wherein
at least the door handle and/or the emergency opening element is/are configured of a plastics material.

19. The door handle according to claim 1, wherein
the emergency opening element is arranged in an opening of the door handle, wherein a sealing element, is provided at least on the emergency opening element and/or on the door handle.

20. The door handle according to claim 1, wherein
the emergency opening element comprises a cover element for covering an opening of the door handle in which the emergency opening element is arranged, and in that the emergency opening element comprises a fastening element that can be brought in mechanical connection with the release apparatus and the traction means.

21. The door handle according to claim 1, wherein
at least the door handle or the emergency opening element, comprise an coating.

22. The door handle according to claim 1, wherein
at least one proximity sensor, is integrated in the door handle, in order to detect a user approaching the motor vehicle.

23. The door handle according to claim 1, wherein
a control unit is provided for the release apparatus, in order to actuate the release apparatus.

24. The door handle according to claim 1, wherein
an emergency power supply is provided for the release apparatus,
and in that the emergency power supply comprises at least one capacitor, a Goldcap capacitor, an accumulator or a foil accumulator in order to supply the release apparatus with energy.

25. An emergency opening system for a vehicle door of a motor vehicle, comprising:
a door handle for a vehicle door of a motor vehicle, comprising a movable emergency opening element which can be brought into a mechanical operative connection with a closure system of the vehicle door,
wherein the emergency opening element comprises a traction means for actuating the closure system, and wherein the emergency opening element is movable between at least two positions, specifically a rest position, in which the emergency opening element is fastened to the door handle, and an operating position, in which the emergency opening element can be actuated by a user, in order to actuate the closure system by pulling on the traction means, and a release apparatus for the emergency opening element, in order to transfer the emergency opening element automatically out of the rest position and into the operating position, wherein the emergency opening element is arranged on a lower side of the door handle and
a closure system at least for locking and unlocking or for opening and closing the vehicle door.

26. The emergency opening system according to claim 25, wherein
a security system is provided for the closure system in order to request authorization of a user.

27. The emergency opening system according to claim 25, wherein
a control unit is provided for the closure system which unit is integrated in a central control unit of the motor vehicle.
